(19) United States
(12) Patent Application Publication
(10) Pub. No.: US 2024/0413931 A1
(43) Pub. Date: Dec. 12, 2024

(54) CHANNEL PUNCTURING INDICATION IN A SOUNDING NULL DATA PACKET (NDP) FRAME

(71) Applicant: Newracom, Inc., Irvine, CA (US)

(72) Inventor: Heejung Yu, Daejeon (KR)

(21) Appl. No.: 18/812,135

(22) Filed: Aug. 22, 2024

Related U.S. Application Data
(63) Continuation of application No. PCT/US23/61758, filed on Feb. 1, 2023.
(60) Provisional application No. 63/268,748, filed on Mar. 1, 2022.

(51) Int. Cl. H04L 1/00; H04L 5/00

(52) U.S. Cl. CPC H04L 1/0069; H04L 5/0044; H04L 5/0094

(57) ABSTRACT

Disclosed herein is a method by wireless device functioning as a beamformer station in a wireless network to indicate a channel puncturing pattern in a null data packet (NDP) sounding frame. The method includes generating the sounding NDP frame, wherein the sounding NDP frame indicates a channel puncturing pattern for a first subchannel of a channel and a channel puncturing pattern for a second subchannel of the channel and wirelessly transmitting the sounding NDP frame in the channel to one or more beamformee stations.

### CROSS-REFERENCE TO RELATED APPLICATION

This application is a continuation of International Patent Application No. PCT/US2023/061758, filed Feb. 1, 2023, which claims the benefit of U.S. Provisional Application No. 63/268,748, filed Mar. 1, 2022, each of which is hereby incorporated by reference.

### TECHNICAL FIELD

The present disclosure generally relates to wireless communications, and more specifically, relates to indicating a channel puncturing pattern in a sounding null data packet (NDP) frame.

### BACKGROUND

Institute of Electrical and Electronics Engineers (IEEE) 802.11 is a set of physical and Media Access Control (MAC) specifications for implementing Wireless Local Area Network (WLAN) communications. These specifications provide the basis for wireless network products using the Wi-Fi brand managed and defined by the Wi-Fi Alliance. The specifications define the use of the 2.400-2.500 Gigahertz (GHz) as well as the 4.915-5.825 GHz bands. These spectrum bands are commonly referred to as the 2.4 GHz and 5 GHz bands. Each spectrum is subdivided into channels with a center frequency and bandwidth. The 2.4 GHz band is divided into 14 channels spaced 5 Megahertz (MHz) apart, though some countries regulate the availability of these channels. The 5 GHz band is more heavily regulated than the 2.4 GHz band and the spacing of channels varies across the spectrum with a minimum of a 5 MHz spacing dependent on the regulations of the respective country or territory.

WLAN devices are currently being deployed in diverse environments. These environments are characterized by the existence of many Access Points (APs) and non-AP stations (STAs) in geographically limited areas. Increased interference from neighboring devices gives rise to performance degradation. Additionally, WLAN devices are increasingly required to support a variety of applications such as video, cloud access, and offloading. Video traffic, in particular, is expected to be the dominant type of traffic in WLAN deployments. With the real-time requirements of some of these applications, WLAN users demand improved performance.

IEEE 802.11be Extremely High Throughput (EHT) is the next amendment of the 802.11 IEEE standard. In the IEEE 802.11be standard, an EHT sounding null data packet (NDP) frame is defined for use in a channel sounding procedure. IEEE 802.11be is expected to support various channel bandwidth options such as 20, 40, 80, 160, and 320 MHz bandwidth, and is also expected to support channel puncturing for efficient spectrum utilization. A U-SIG field of the EHT sounding NDP frame may include 3-bit bandwidth information to indicate the channel bandwidth and 5-bit channel puncturing information to indicate a channel puncturing pattern. An EHT-SIG field of the EHT sounding NDP frame may be used to indicate resource unit (RU) and multiple RU (MRU) allocation information. The RU/MRU allocation bits may indicate the subcarrier (e.g., bandwidth with fine granularity), which is used for data transmission. However, the EHT sounding NDP frame does not include any payload/data and so does not include RU allocation information. This means that channel allocation (e.g., the bandwidth being used) can only be indicated by the 5-bit channel puncturing pattern information. Due to this, the flexibility of channel allocation that can be indicated in the EHT sounding NDP frames is very limited. This limitation can cause inefficient spectrum utilization and unnecessary feedback of beamforming report field in the EHT compressed beamforming/CQI (channel quality indication) report frames.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example wireless local area network (WLAN) with a basic service set (BSS) that includes a plurality of wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates Inter-Frame Space (IFS) relationships, in accordance with some embodiments of the present disclosure.

FIG. 5 illustrates a Carrier Sense Multiple Access/Collision Avoidance (CSMA/CA) based frame transmission procedure, in accordance with some embodiments of the present disclosure.

FIG. 6 shows a table comparing various iterations of Institute of Electrical and Electronics Engineers (IEEE) 802.11 standard, in accordance with some embodiments of the present disclosure.

FIG. 7 shows a table, which describes fields of an Extreme High Throughput (EHT) frame format, in accordance with some embodiments of the present disclosure.

FIG. 8 is a diagram showing an explicit channel sounding procedure in IEEE 802.11be.

FIG. 9 is a diagram showing an EHT sounding NDP frame format.

FIG. 10 is a diagram showing 5-bit channel puncturing pattern indication in U-SIG field for an EHT sounding NDP frame.

FIG. 11 is a diagram showing the inefficiency of current 5-bit channel puncturing pattern indication in an OBSS scenario.

FIG. 12 is a diagram showing a modified EHT sounding NDP frame format for a 320 MHz channel bandwidth, according to some embodiments.

FIG. 13 is a diagram showing an “even-odd” EHT sounding NDP frame format for a 320 MHz channel bandwidth, according to some embodiments.

FIG. 14 is a flow diagram showing a method for indicating a channel puncturing pattern in a sounding NDP frame, according to some embodiments.

FIG. 15 is a flow diagram showing a method for determining a channel puncturing pattern from a sounding NDP frame, according to some embodiments.

### DETAILED DESCRIPTION

The present disclosure generally relates to wireless communications, and more specifically, relates to indicating a channel puncturing pattern in a sounding null data packet (NDP) frame. Existing channel puncturing pattern indication methods use five bits of the U-SIG field of the sounding NDP frame to indicate the channel puncturing pattern. However, this is not sufficient to express various channel puncturing patterns, particularly when the channel bandwidth is 320 Megahertz (MHz). With existing methods, when the channel bandwidth is 320 MHz, channel puncturing patterns with 40 MHz, 80 MHz, and 80+40 MHz channel puncturing units can be indicated. However, it is not possible to indicate channel puncturing patterns with 20 MHz channel puncturing unit (finer granularity). Embodiments disclosed herein allow for indicating channel puncturing patterns with 20 MHz channel puncturing unit when the channel bandwidth is 320 MHz. Embodiments achieve this by modifying and/or reinterpreting the existing sounding NDP frame.

An embodiment is a method performed by a wireless device functioning as a beamformer station in a wireless network to indicate a channel puncturing pattern for a sounding NDP frame. The method includes generating the sounding NDP frame, wherein the sounding NDP frame indicates a channel puncturing pattern for a first subchannel of a channel and a channel puncturing pattern for a second subchannel of the channel and wirelessly transmitting the sounding NDP frame in the channel to one or more beamformee stations. In an embodiment, a U-SIG field wirelessly transmitted in the first subchannel is used to indicate the channel puncturing pattern for the first subchannel and another U-SIG field wirelessly transmitted in the second subchannel is used to indicate the channel puncturing pattern for the second subchannel. In an embodiment, the channel includes a plurality of odd numbered subchannels and a plurality of even numbered subchannels, and U-SIG fields wirelessly transmitted in the plurality of odd subchannels are used to indicate the channel puncturing pattern for the first subchannel and U-SIG fields wirelessly transmitted in the plurality of even subchannels are used to indicate the channel puncturing pattern for the second subchannel. In an embodiment, “channel puncturing information” bits (e.g., B3 to B7) of a U-SIG-2 field are used to indicate the channel puncturing pattern for the first subchannel and the “disregard” bits (e.g., B20 to B24) of a U-SIG-1 field are used to indicate the channel puncturing pattern for the second subchannel. In an embodiment, a U-SIG field is used to indicate the channel puncturing pattern for the first subchannel and an EHT-SIG field with two symbols is used to indicate the channel puncturing pattern for the second subchannel.

An embodiment is a method performed by a wireless device functioning as a beamformee station in a wireless network to determine a channel puncturing pattern indicated by a sounding NDP frame. The method includes wirelessly receiving the sounding NDP frame in a channel, wherein the sounding NDP frame indicates a bandwidth of the channel, a channel puncturing pattern for a first subchannel of the channel, and a channel puncturing pattern for a second subchannel of the channel and responsive to determining that the bandwidth of the channel indicated by the sounding NDP frame is a particular bandwidth (e.g., 320 MHz), determining the channel puncturing pattern for the first subchannel and the channel puncturing pattern for the second subchannel from the sounding NDP frame. In an embodiment, the channel puncturing pattern for the first subchannel is determined from a U-SIG field wirelessly received in the first subchannel and the channel puncturing pattern for the second subchannel is determined from a U-SIG field wirelessly received in the second subchannel. In an embodiment, the channel includes a plurality of odd numbered subchannels and a plurality of even numbered subchannels, and the channel puncturing pattern for the first subchannel is determined from a U-SIG field wirelessly received in one or more of the plurality of odd numbered subchannels and the channel puncturing pattern for the second subchannel is determined from another U-SIG field wirelessly received in one or more of the plurality of even numbered subchannels. In an embodiment, the channel puncturing pattern for the first subchannel is determined from “channel puncturing information” bits (e.g., bits B3 to B7) of a U-SIG-2 field and the channel puncturing pattern for the second subchannel is determined from “disregard” bits (e.g., bits B20 to B24) of a U-SIG-1 field. In an embodiment, the channel puncturing pattern for the first subchannel is determined from a U-SIG field and the channel puncturing pattern for the second subchannel is determined from an EHT-SIG field with two symbols.

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

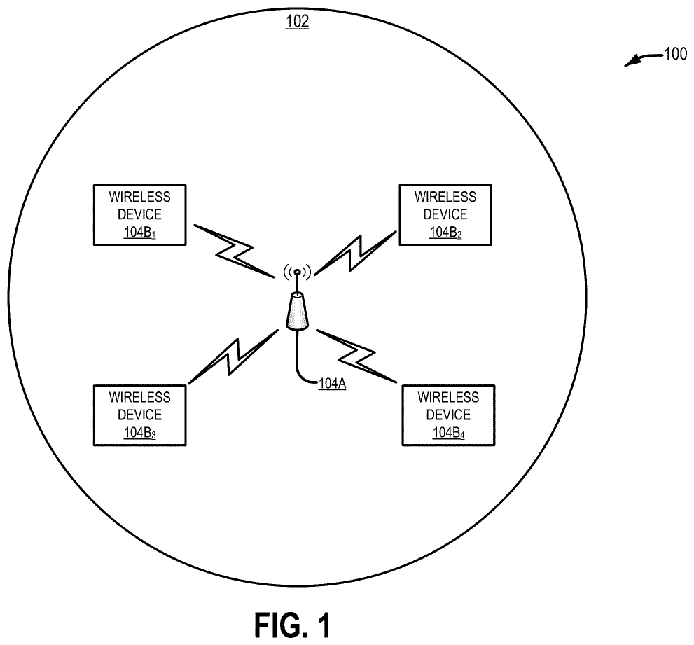

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs. Although shown with four non-AP STAs (e.g., the wireless devices 104B₁-104B₄), the WLAN 100 may include any number of non-AP STAs (e.g., one or more wireless devices 104B).

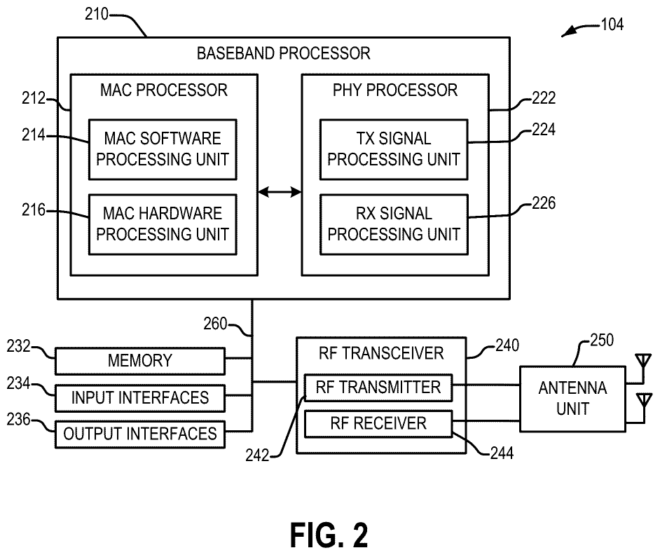

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

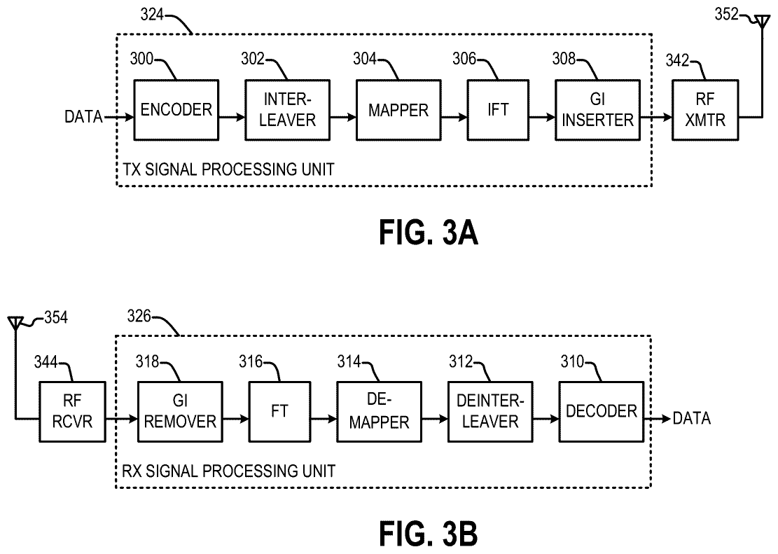

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

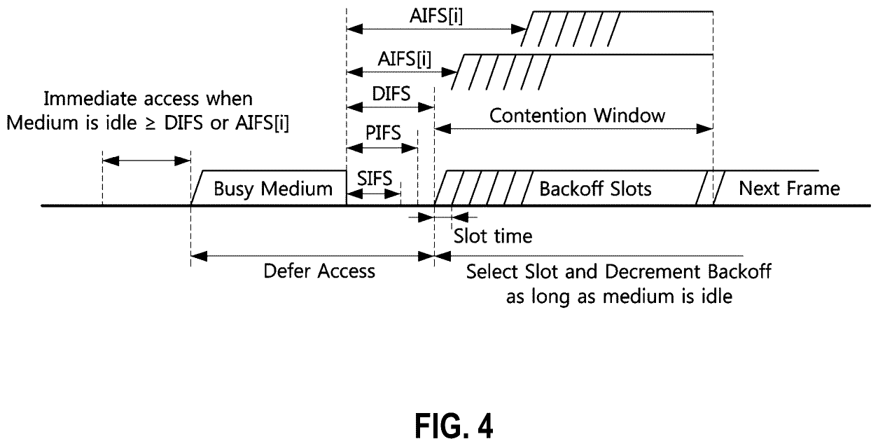

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QoS) functionality (that is, a QoS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

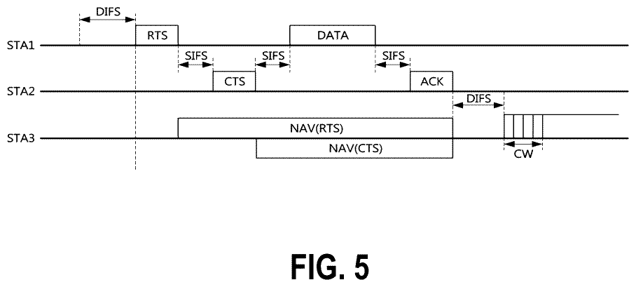

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

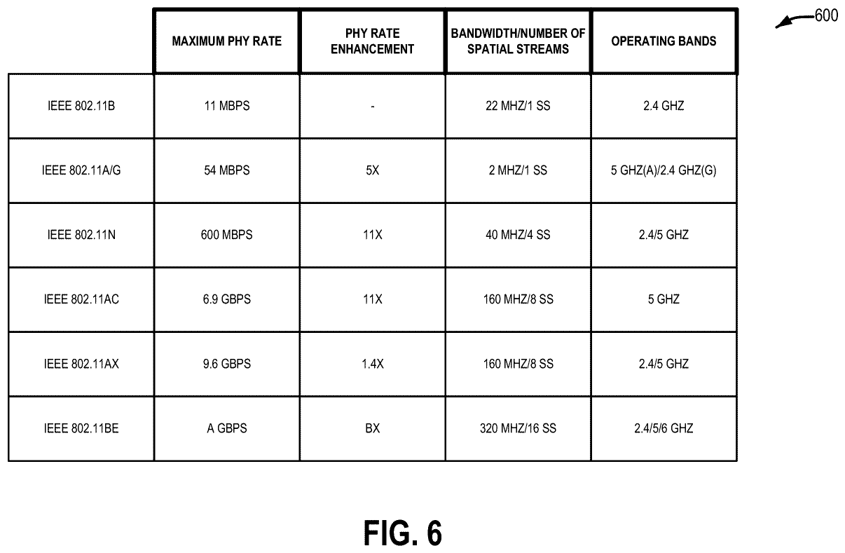

With clear demand for higher peak throughput/capacity in a WLAN, a new working group has been assembled to generate an amendment to IEEE 802.11. This amendment is called IEEE 802.11be (i.e., Extreme High Throughput (EHT)) and was created to support an increase to the peak PHY rate of a corresponding WLAN. Considering IEEE 802.11b through 802.11ac, the peak PHY rate has been increased by 5× to 11× as shown in FIG. 6, which presents a table 600 comparing various iterations of IEEE 802.11. In case of IEEE 802.11ax, the 802.11ax working group focused on improving efficiency, not peak PHY rate in dense environments. The maximum PHY rate (A Gbps) and PHY rate enhancement (Bx) for IEEE 802.11be could rely on the highest MCS (e.g., 4,096 QAM and its code rate).

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHz) for IEEE 802.11be, more than 1 GHz of additional unlicensed spectrum is likely to be available because the 6 GHz band (5.925-7.125 GHz) is being considered for unlicensed use. This would allow APs and STAs to become tri-band devices. Larger than 160 MHz data transmissions (e.g., 320 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

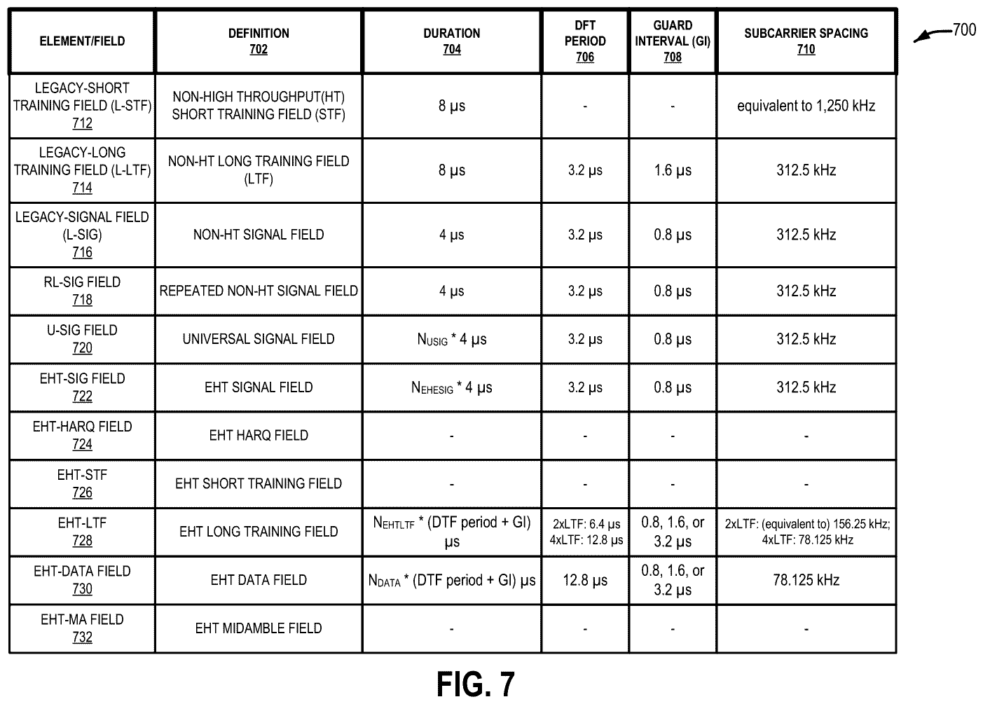

In some embodiments, a transmitting STA generates a PPDU frame and transmits it to a receiving STA. The receiving STA receives, detects, and processes the PPDU. The PPDU can be an EHT PPDU that includes a legacy part (e.g., a legacy short training field (L-STF), a legacy long training field (L-LTF), and a legacy signal (L-SIG) field), an EHT signal A field (EHT-SIG-A), an EHT signal B field (EHT-SIG-B), an EHT hybrid automatic repeat request field (EHT-HARQ), an EHT short training field (EHT-STF), an EHT long training field (EHT-LTF), and an EHT-DATA field. FIG. 7 includes a table 700, which describes fields of an EHT frame format. In particular, table 700 describes various fields that may be within the PHY preamble, data field, and midamble of an EHT frame format. For example, table 700 includes definitions 702, durations 704, Discrete Fourier transform (DFTs) periods 706, guard intervals (GIs) 708, and subcarrier spacings 710 for one or more of a legacy short training field (L-STF) 712, legacy long training field (L-LTF) 714, legacy signal field (L-SIG) 716, repeated L-SIG (RL-SIG) 718, universal signal field (U-SIG) 720, EHT signal field (EHT-SIG) 722, EHT hybrid automatic repeat request field (EHT-HARQ) 724, EHT short training field (EHT-STF) 726, EHT long training field (EHT-LTF) 728, EHT data field 730, and EHT midamble field (EHT-MA) 732.

The distributed nature of a channel access network, such as in IEEE 802.11 wireless networks, makes carrier sensing mechanisms important for collision free operation. The physical carrier sensing mechanism of one STA is responsible for detecting the transmissions of other STAs. However, it may be impossible to detect every single case in some circumstances. For example, one STA which may be a long distance away from another STA may see the medium as idle and begin transmitting a frame while the other STA is also transmitting. To overcome this hidden node, a network allocation vector (NAV) may be used. However, as wireless networks evolve to include simultaneous transmission/reception to/from multiple users within a single basic service set (BSS), such as uplink(UL)/downlink(DL) multi-user (MU) transmissions in a cascading manner, a mechanism may be needed to allow for such a situation. As used herein, a multi-user (MU) transmission refers to cases that multiple frames are transmitted to or from multiple STAs simultaneously using different resources. Examples of different resources are different frequency resources in OFDMA transmissions and different spatial streams in MU-MIMO transmissions. Therefore, DL-OFDMA, DL-MU-MIMO, UL-OFDMA, and UL-MU-MIMO are examples of MU transmissions.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HAPQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

To improve WLAN systems, AP cooperation has been discussed as a possible technology to be adopted in IEEE 802.11be, where there is high level classification depending on various AP cooperation schemes. For example, there is a first type of cooperation scheme in which data for a user is sent from a single AP (sometimes referred to as “coordinated”) and there is a second type of cooperation scheme in which data for a user is sent from multiple APs (sometimes referred to as “joint”).

For the coordinated scheme, multiple APs are 1) transmitting on the same frequency resource based on coordination and forming spatial nulls to allow for simultaneous transmission from multiple APs or 2) transmitting on orthogonal frequency resources by coordinating and splitting the spectrum to use the spectrum more efficiently. For the joint scheme, multiple APs are transmitting jointly to a given user.

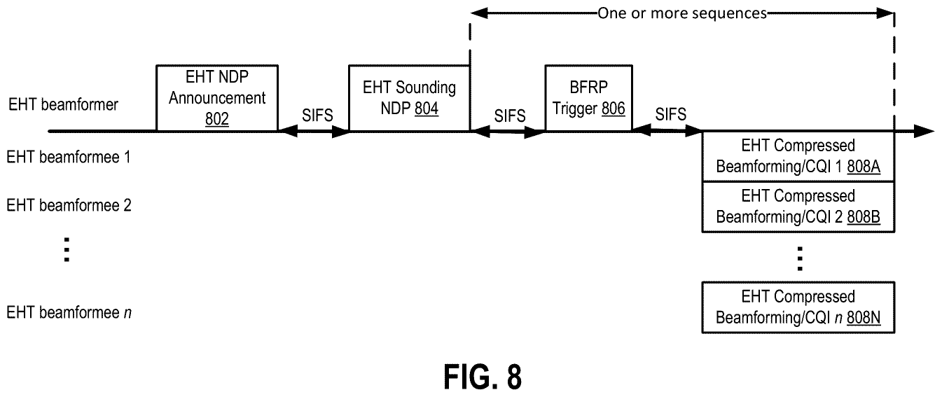

The current draft of IEEE 802.11be support single-user and multi-user beamforming based on OFDM(A). For beamformed transmission and OFDMA scheduling, a channel sounding process is needed. For this purpose, the current draft of IEEE 802.11be provides explicit channel sounding procedures such as the one shown in FIG. 8.

FIG. 8 is a diagram showing an explicit channel sounding procedure in IEEE 802.11be. As shown in the diagram, the procedure is initiated by an EHT beamformer transmitting a EHT NDP announcement frame 802. After a SIFS interval, the EHT beamformer transmits an EHT sounding NDP frame 804 to EHT beamformees (e.g., EHT beamformees 1-n) to allow the EHT beamformees to estimate the channel matrix and calculate the beam matrix. After another SIFS interval, the EHT beamformer transmits a beamforming report poll (BFRP) trigger frame 806. In response, the EHT beamformees transmit EHT CBF/CQI (compressed beamforming channel quality indicator) frames 808 (e.g., EHT compressed beamforming/CQI frames 808A-N). The transmission of the BFRP trigger frame 806 and the EHT CBF/CQI frames 808 may be repeated one or multiple times until all feedback information is fed back.

For beamformed transmission, the beamformees feedback the beamforming weights and respective CQIs, which are used by the beamformer for beamforming.

For scheduling of OFDMA transmission (e.g., in order to determine where (e.g., which frequency) is the best RU to allocate a specific STA in a multi-user transmission, and with what parameters (e.g., MCS, Nss etc.) to allocate), a beamformer (e.g., an AP) initiates a sounding procedure. As a response, beamformees (e.g., non-AP STAs) feedback CQI for the requested RUs or the entire bandwidth.

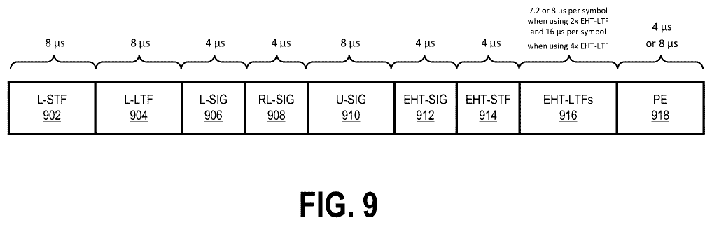

FIG. 9 is a diagram showing an EHT sounding NDP frame format. As shown in the diagram, the EHT sounding NDP frame format includes a L-STF field 902 (8 μs), a L-LTF field 904 (8 μs), a L-SIG field 906 (4 μs), a RL-SIG field 908 (4 μs), a U-SIG field 910 (8 μs), an EHT-SIG field 912 (4 μs), an EHT-STF field 914 (4 μs), EHT-LTF fields 916 (7.2 μs or 8 μs per symbol when using 2×EHT-LTF and 16 μs when using 4×EHT-LTF), and a PE field 918 (4 μs or 8 μs). For sake of explanation, embodiments are described herein in the context of 802.11 wireless standards and using terminology borrowed from the wireless standards.

The EHT sounding NDP frame may be an EHT MU PPDU with a single EHT-SIG symbol encoded using EHT-MCS 0 and have no data field. The EHT-SIG field 912 may include a common field (common field for EHT sounding NDP frame) and no user specific field. The common field for EHT sounding NDP frame may include 26 bits with the following information (Bn represents bit position n):
B0-B3: Spatial Reuse
B4-B5: GI+LTF Size
B6-B8: Number of EHT-LTF Symbols
B9-B12: NSS
B13: Beamformed
B14-B15: Disregard
B16-B19: CRC
B20-B25: Tail

The U-SIG field of an EHT MU PPDU may include a U-SIG-1 field and a U-SIG-2 field.

The U-SIG-1 field may include the following information:
B0-B2: PHY Version Identifier
B3-B5: BW
B6: UL/DL
B7-B12: BSS color
B13-B19: TXOP
B20-B24: Disregard
B25: Validate

The U-SIG-2 field may include the following information:
B0-B1: PPUD Type and Compressed Mode
B2: Validate
B3-B7: Punctured Channel Information (also referred to as “channel puncturing information”)
B8: Validate
B9-B10: EHT-SIG MCS
B11-B15: Number of EHT-SIG Symbols
B16-B19: CRC
B20-B25: Tail

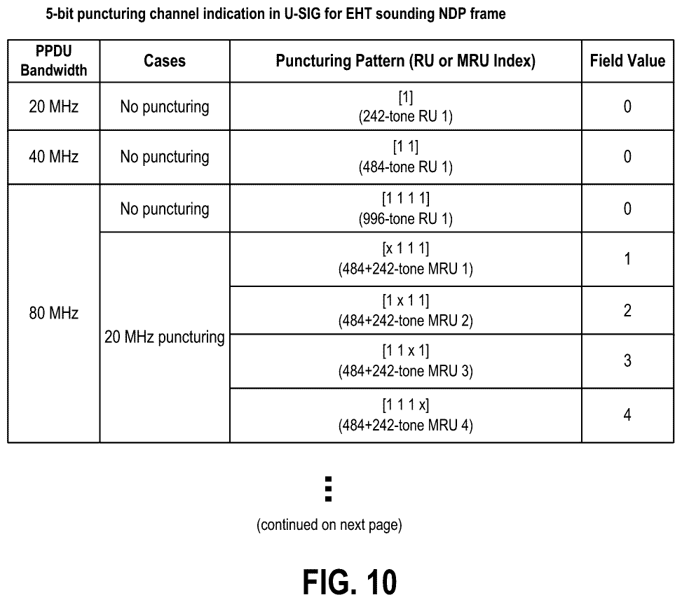

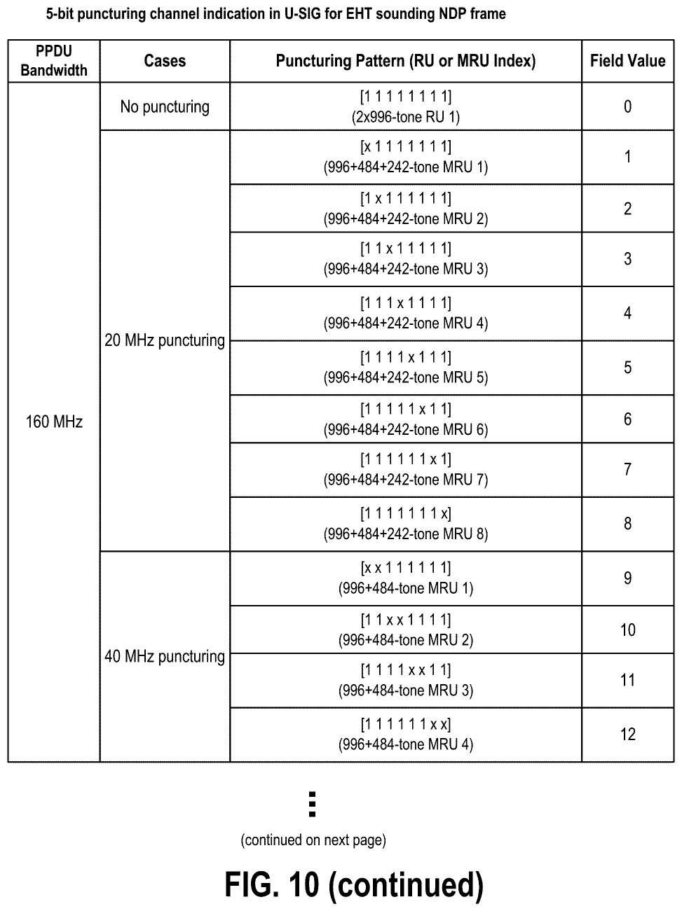

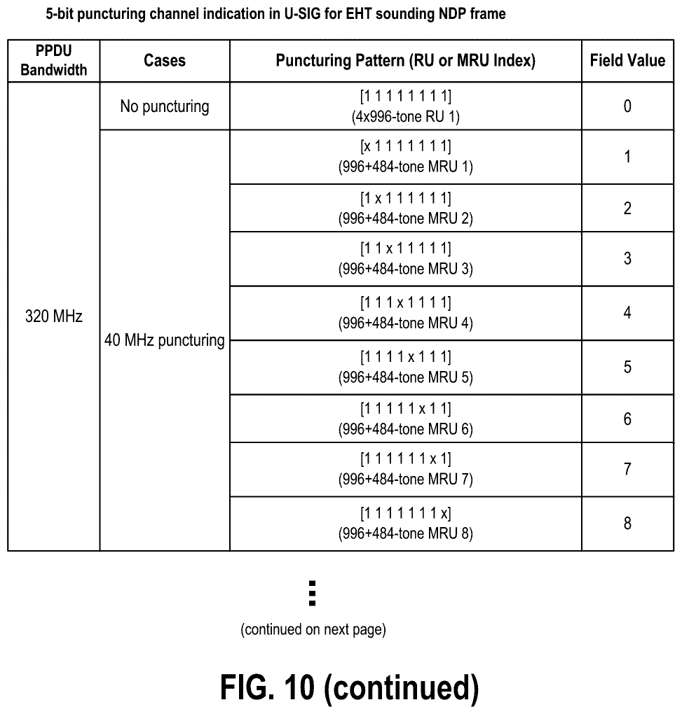

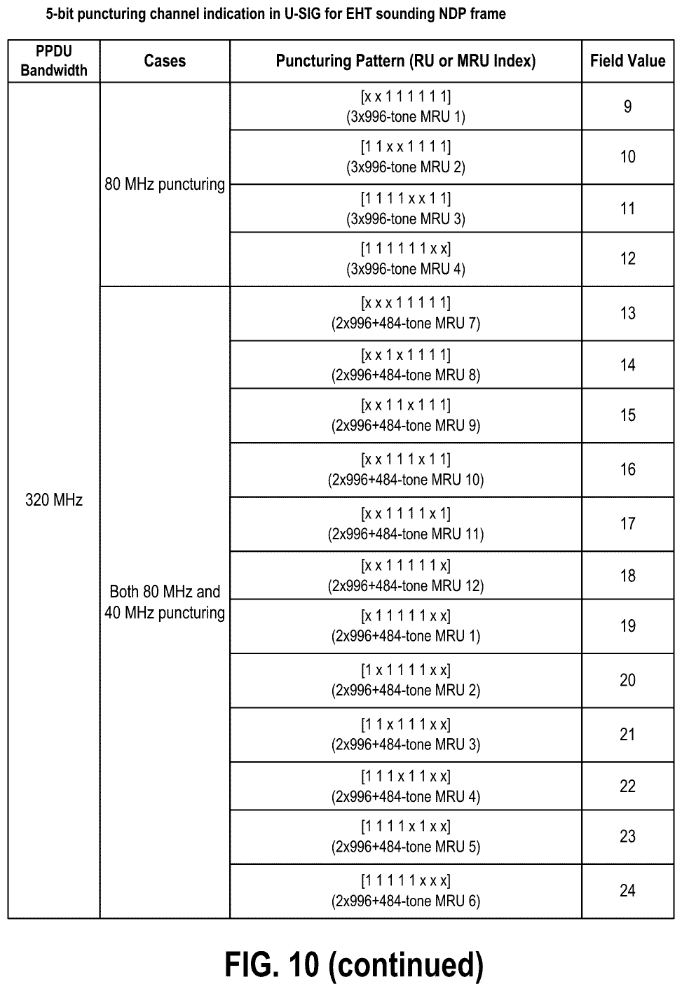

In the EHT sounding NDP frame, the “channel puncturing information” bits of the U-SIG field can be used to signal the puncturing of the 242-tone RUs in overlapping 20 MHz channels (e.g., when the beamformer wants to use 80 MHz channel but 20 MHz subchannel in the 80 MHz channel overlaps with other AP's channel). The channel puncturing patterns that can be indicated using the 5-bit channel puncturing indication are shown in FIG. 10. For 20 MHz, 40 MHz, 80 MHz, and 160 MHz bandwidth cases, the granularity of the channel puncturing (the channel puncturing unit) is 20 MHz or 40 MHz. With these bandwidths, the 5-bit channel puncturing pattern indication can cover almost all possible channel puncturing patterns. With the 320 MHz bandwidth case, the granularity of the channel puncturing is 40 MHz, 80 MHz, or 40+80 MHz. It should be noted that with the 320 MHz bandwidth case, the 5-bit channel puncturing pattern indication cannot be used to express channel puncturing patterns using a channel puncturing unit of 20 MHz.

FIG. 10 is a diagram showing 5-bit channel puncturing pattern indication in U-SIG field for an EHT sounding NDP frame. As shown in the diagram, for 20 MHz PPDU bandwidth case, a single channel puncturing pattern (i.e., “no puncturing”) can be expressed. Similarly, for 40 MHz PPDU bandwidth case, a single channel puncturing pattern (i.e., “no puncturing”) can be expressed. For 160 MHz PPDU bandwidth case, 13 channel puncturing patterns can be expressed using 20 MHz and 40 MHz channel puncturing units. For 320 MHz PPDU bandwidth case, 25 channel puncturing patterns can be expressed using 40 MHz, 80 MHz, and 40+80 Mhz channel puncturing units. It should be noted, however, that channel puncturing patterns cannot be expressed using 20 MHz channel puncturing units (finer granularity) in the 320 MHz bandwidth case. In the “puncturing pattern” column “1” represents non-punctured and “x” represents punctured.

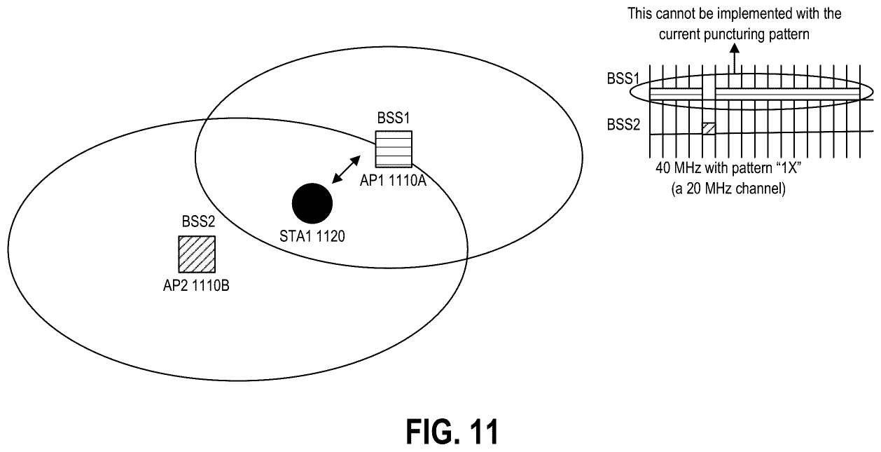

FIG. 11 is a diagram showing the inefficiency of current 5-bit channel puncturing pattern indication in an OBSS scenario. As shown in the diagram, BSS1 with AP1 1110A and associated STA1 1120 can support 320 MHz bandwidth. The overlapping BSS2 with AP2 1110B operates in 40 MHz channel bandwidth and one of the 20 MHz subchannels is punctured with the pattern “1X,” meaning that only the upper 20 MHz subchannel is used for transmission (lower 20 MHz subchannel is punctured). Thus, the available channel in BSS1 is a 320 MHz channel with 20 MHz puncturing. With the current channel puncturing pattern indication method, two scenarios are possible. In the first scenario, EHT sounding NDP frame is sent with the channel puncturing pattern of “11X11111” using 40 MHz channel puncturing unit. In this case, the available 20 MHz subchannel is not utilized. In the second scenario, the EHT sounding NDP frame is sent with no channel puncturing because AP1 1110A cannot sense the channel of BSS2. As a result, STA1 will feedback EHT compressed beamforming/CQI information for the entire 320 MHz bandwidth. However, the beamformee may unscheduled the 20 MHz subchannel because the quality of the subchannel is too low due to interference by BSS2. As a result, unnecessary beamforming weight and CQI values may be fed back due to the inability to express channel puncturing pattern using 20 MHz channel puncturing unit.

Embodiments address the problems mentioned above by providing a way to indicate channel puncturing patterns with finer granularity (e.g., using 20 MHz channel puncturing unit in a 320 MHz bandwidth case).

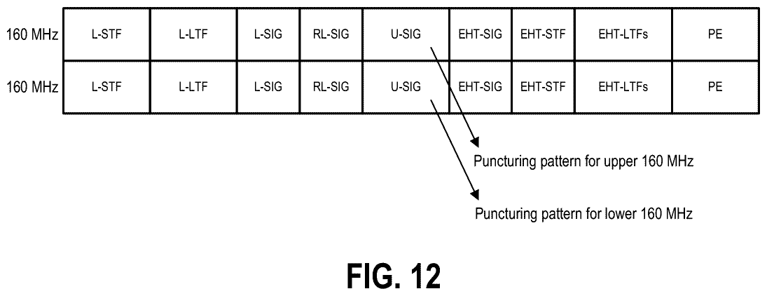

A first embodiment for indicating channel puncturing pattern uses a new 320 MHz EHT sounding NDP frame format as shown in FIG. 12.

FIG. 12 is a diagram showing a modified EHT sounding NDP frame format for a 320 MHz channel bandwidth, according to some embodiments. As shown in the diagram, the EHT sounding NDP frame format includes two U-SIG fields, where the first U-SIG field is transmitted in the upper 160 MHz subchannel and the second U-SIG field is transmitted in the lower 160 MHz subchannel. The two U-SIG fields may be used to indicate the channel puncturing patterns for their respective 160 MHz subchannels. That is, the first U-SIG field transmitted in the upper 160 MHz subchannel may be used to indicate the channel puncturing pattern for the upper 160 MHz subchannel and the second U-SIG field transmitted in the lower 160 MHz subchannel may be used to indicate the channel puncturing pattern for the lower 160 MHz subchannel. Other than the U-SIG fields, the other parts of the EHT sounding NDP frame format may be same as the EHT sounding NDP frame format of the existing wireless standard draft.

If the channel bandwidth is 320 MHz, the upper and lower 160 MHz subchannels may have different puncturing patterns as indicated by the U-SIG field transmitted in the respective 160 MHz subchannels. The 5-bit channel puncturing pattern indication can be used to express the channel puncturing pattern for each 160 MHz subchannel. If the bandwidth bits of the U-SIG field indicate that the channel bandwidth is 320 MHz, the receiver may decode the U-SIG fields in the upper and lower 160 MHz subchannels, respectively, and identify the channel puncturing patterns for the upper and lower 160 MHz subchannels from the corresponding U-SIG fields. As a result, the 320 MHz PPDU bandwidth cases in the 5-bit channel puncturing pattern indication shown in FIG. 10 may not be needed. In an embodiment, only four bits may be needed to indicate the channel puncturing pattern (e.g., for a particular 160 MHz subchannel). In the examples described above, the 320 MHz channel is divided into upper and lower 160 MHz subchannels. In an embodiment, the upper and lower 160 MHz subchannels can be 160 MHz subchannels with and without a primary channel (e.g., 160 MHz subchannel that includes the primary 20 MHz subchannel and 160 MHz subchannel that does not include the primary 20 MHz subchannel), respectively.

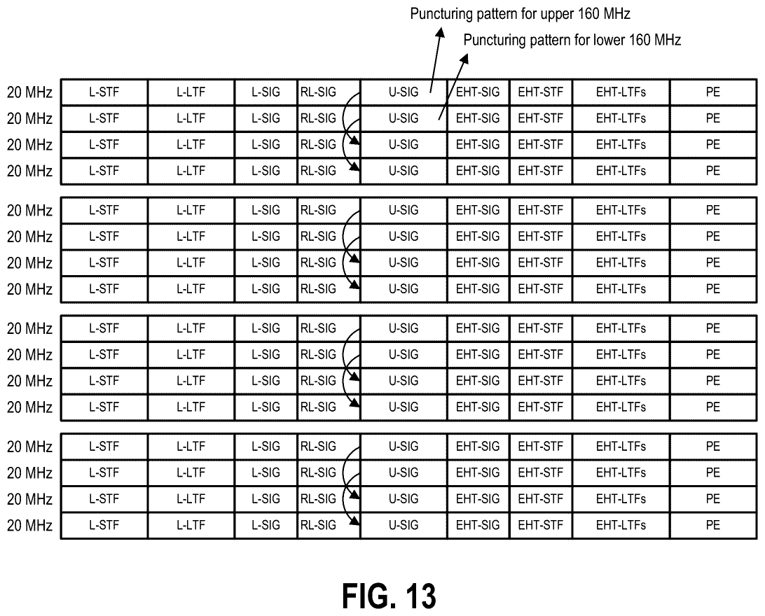

A second embodiment for indicating channel puncturing pattern uses a new 320 MHz EHT sounding NDP frame format as shown in FIG. 13.

FIG. 13 is a diagram showing an “even-odd” EHT sounding NDP frame format for a 320 MHz channel bandwidth, according to some embodiments. As shown in the diagram, the 320 MHz channel may be divided into sixteen 20 MHz subchannels. Thus, there are a total of eight odd numbered 20 MHz subchannels (the 1^{st}, 3^{rd}, 5^{th}, 7^{th}, 9^{th}, 11^{th}, 13^{th}, and 15^{th} 20 MHz subchannels) and a total of eight even numbered subchannels (the 2^{nd}, 4^{th}, 6^{th}, 8^{th}, 10^{th}, 12^{th}, 14^{th}, and 16^{th} 20 MHz subchannels). In an embodiment, the U-SIG fields transmitted in the odd numbered subchannels are the same (they are duplicates of each other) and are used to indicate the channel puncturing pattern for the upper 160 MHz subchannel and the U-SIG fields transmitted in the even numbered subchannels are the same (duplicates of each other) and are used to indicate the channel puncturing pattern for the lower 160 MHz subchannel (or vice versa). The channel puncturing pattern for the upper 160 MHz subchannel may be different from the channel puncturing pattern for the lower 160 MHz subchannel. Other than the U-SIG fields, the other parts of the EHT sounding NDP frame format may be the same as the EHT sounding NDP frame format of the existing wireless standard draft.

A third embodiment for indicating channel puncturing pattern uses the “disregard” bits (5 bits) of the U-SIG-1 field to indicate channel puncturing pattern when the EHT sounding NDP frame is transmitted using 320 MHz channel bandwidth. Since sounding NDP frames are only used during the channel sounding procedure and do not carry any payload/data to the receiver(s), the “disregard” bits of the U-SIG-1 field can be used for the special purpose of indicating channel puncturing pattern. For example, the “channel puncturing information” bits (e.g., 5 bits) of the U-SIG-2 field may be used to indicate the channel puncturing pattern for the upper 160 MHz subchannel and the “disregard” bits (e.g., 5 bits) of the U-SIG-2 field may be used to indicate the channel puncturing pattern for the lower 160 MHz subchannel (or vice versa) when a given frame is the EHT sounding NDP frame with 320 MHz channel bandwidth. Moreover, in this case, as previously mentioned, 5-bit channel puncturing pattern indication can be reduced to four bits because 320 MHz channel puncturing patterns are not needed. Then, the five “channel puncturing information” bits (of the U-SIG-2 field) and three bits out of the five “disregard” bits (of the U-SIG-1 field) can be used to indicate two channel puncturing patterns for the upper and lower 160 MHz subchannels (e.g., four out of the eight bits can be used to indicate the channel puncturing pattern for the upper 160 MHz subchannel and the other four bits can be used to indicate the channel puncturing pattern for the lower 160 MHz subchannel).

A fourth embodiment for indicating channel puncturing pattern uses an extra EHT-SIG symbol. In an embodiment, if the “bandwidth” bits in the U-SIG field indicate that the bandwidth is 320 MHz, the number of EHT-SIG symbols is extended to two symbols. The extra symbol may be used to indicate an additional channel puncturing pattern. Thus, for example, the five “channel puncturing information” bits of the U-SIG field can be used to indicate the channel puncturing pattern for the upper (or primary) 160 MHz subchannel and the additional five “channel puncturing information” bits in the extra EHT-SIG symbol may be used to indicate the channel puncturing pattern for the lower (or secondary) 160 MHz subchannel (or vice versa).

A method to indicate a channel puncturing pattern in an EHT sounding NDP frame is disclosed herein. Embodiments provide a more flexible way to indicate channel puncturing patterns in an EHT sounding NDP frame when 320 MHz channel bandwidth is being used. This allows embodiments to efficiently use the available spectrum even in complicated OBSS network environments. Moreover, embodiments can avoid unnecessary feedback from being provided in the beamforming report field in the EHT compressed beamforming/CQI report frames.

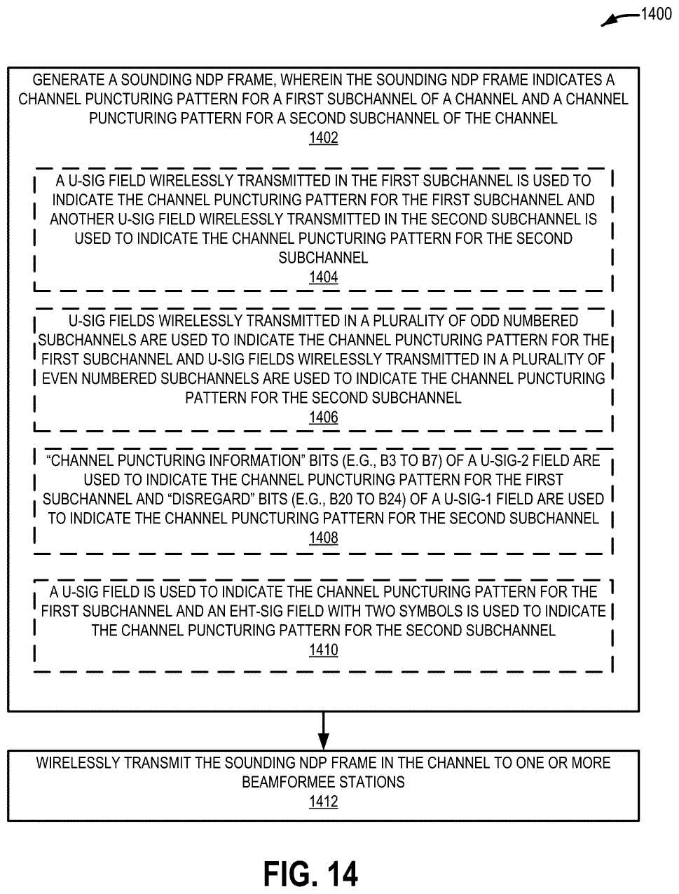

Turning now to FIG. 14, a method 1400 will be described for indicating a channel puncturing pattern in a sounding NDP frame, in accordance with an example embodiment. The method 1400 may be performed by one or more devices described herein. For example, the method 1400 may be performed by a wireless device 104 functioning as a beamformer station (e.g., an AP) in a wireless network.

Additionally, although shown in a particular order, in some embodiments the operations of the method 1400 (and the other methods shown in the other figures) may be performed in a different order. For example, although the operations of the method 1400 are shown in a sequential order, some of the operations may be performed in partially or entirely overlapping time periods.

As shown in FIG. 14, the method 1400 may commence at operation 1402 with a beamformer station generating a sounding NDP frame, wherein the sounding NDP frame indicates a channel puncturing pattern for a first subchannel of a channel and a channel puncturing pattern for a second subchannel of the channel.

In an embodiment, the channel has a bandwidth of 320 MHz, the first subchannel has a bandwidth of 160 MHz, and the second subchannel has a bandwidth of 160 MHz. In an embodiment, the sounding NDP frame includes a first field and a second field, wherein the first field is used to indicate the channel puncturing pattern for the first subchannel and the second field is used to indicate the channel puncturing pattern for the second subchannel.

In an embodiment, as shown in block 1404, a U-SIG field wirelessly transmitted in the first subchannel is used to indicate the channel puncturing pattern for the first subchannel and another U-SIG field wirelessly transmitted in the second subchannel is used to indicate the channel puncturing pattern for the second subchannel.

In an embodiment, the channel includes a plurality of odd numbered subchannels (e.g., eight odd numbered 20 MHz subchannels of a 320 MHz channel) and a plurality of even numbered subchannels (e.g., eight odd numbered 20 MHz subchannels of a 320 MHz channel). In an embodiment, as shown in block 1406, U-SIG fields wirelessly transmitted in the plurality of odd subchannels are used to indicate the channel puncturing pattern for the first subchannel and U-SIG fields wirelessly transmitted in the plurality of even subchannels are used to indicate the channel puncturing pattern for the second subchannel.

In an embodiment, as shown in block 1408, “channel puncturing information” bits (e.g., B3 to B7) of a U-SIG-2 field are used to indicate the channel puncturing pattern for the first subchannel and the “disregard” bits (e.g., B20 to B24) of a U-SIG-1 field are used to indicate the channel puncturing pattern for the second subchannel.

In an embodiment, as shown in block 1410, a U-SIG field is used to indicate the channel puncturing pattern for the first subchannel and an EHT-SIG field with two symbols is used to indicate the channel puncturing pattern for the second subchannel.

In an embodiment, the sounding NDP frame includes a first field and a second field, wherein four bits in the first field (e.g., four of the “channel puncturing information” bits of the U-SIG-2 field) are used to indicate the channel puncturing pattern for the first subchannel, wherein one bit in the first field and three bits in the second field (e.g., three of the “disregard” bits of the U-SIG-1 field) are used to indicate the channel puncturing pattern for the second subchannel.

At operation 1412, the beamformer station wirelessly transmits the sounding NDP frame in the channel to one or more beamformee stations.

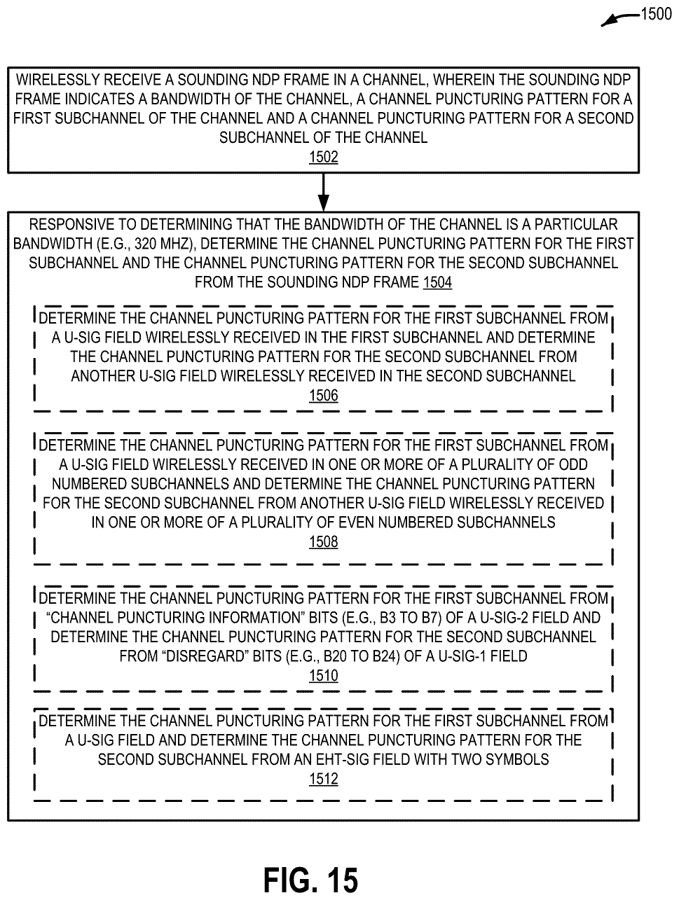

Turning now to FIG. 15, a method 1500 will be described for determining a channel puncturing pattern from a sounding NDP frame, in accordance with an example embodiment. The method 1500 may be performed by one or more devices described herein. For example, the method 1500 may be performed by a wireless device 104 functioning as a beamformee station (e.g., a non-AP STA) in a wireless network.

As shown in FIG. 15, the method 1500 may commence at operation 1502 with a beamformee station wirelessly receiving a sounding NDP frame in a channel, wherein the sounding NDP frame indicates a bandwidth of the channel, a channel puncturing pattern for a first subchannel of the channel, and a channel puncturing pattern for a second subchannel of the channel.

At operation 1504, responsive to determining that the bandwidth of the channel is a particular bandwidth (e.g., 320 MHz), the beamformee station determines the channel puncturing pattern for the first subchannel and the channel puncturing pattern for the second subchannel from the sounding NDP frame.

In an embodiment, the particular bandwidth is 320 MHz, wherein the first subchannel has a bandwidth of 160 MHz and the second subchannel has a bandwidth of 160 MHz. In an embodiment, the beamformee station determines the channel puncturing pattern for the first subchannel from a first field of the sounding NDP frame and determines the channel puncturing pattern for the second subchannel from a second field of the sounding NDP frame.

In an embodiment, the first field is wirelessly received in the first subchannel and the second field is wirelessly received in the second subchannel. In an embodiment, as shown in block 1506, the beamformee station determines the channel puncturing pattern for the first subchannel from a U-SIG field wirelessly received in the first subchannel and determines the channel puncturing pattern for the second subchannel from a U-SIG field wirelessly received in the second subchannel.

In an embodiment, the channel includes a plurality of odd numbered subchannels (e.g., eight odd numbered 20 MHz subchannels of a 320 MHz channel) and a plurality of even numbered subchannels (e.g., eight even numbered 20 MHz subchannels of a 320 MHz channel). In an embodiment, as shown in block 1508, the beamformee station determines the channel puncturing pattern for the first subchannel from a U-SIG field wirelessly received in one or more of the plurality of odd numbered subchannels and determines the channel puncturing pattern for the second subchannel from another U-SIG field wirelessly received in one or more of the plurality of even numbered subchannels.

In an embodiment, as shown in block 1510, the beamformee station determines the channel puncturing pattern for the first subchannel from “channel puncturing information” bits (e.g., bits B3 to B7) of a U-SIG-2 field and determines the channel puncturing pattern for the second subchannel from “disregard” bits (e.g., bits B20 to B24) of a U-SIG-1 field.

In an embodiment, as shown in block 1512, the beamformee station determines the channel puncturing pattern for the first subchannel from a U-SIG field and determines the channel puncturing pattern for the second subchannel from an EHT-SIG field with two symbols.

In an embodiment, the beamformee station determines the channel puncturing pattern for the first subchannel from four bits in a first field of the sounding NDP frame (e.g., four of the “channel puncturing information” bits of the U-SIG-2 field) and determines the channel puncturing pattern for the second subchannel from one bit in the first field and three bits in a second field of the sounding NDP frame (e.g., three of the “disregard” bits of the U-SIG-1 field).

In an embodiment, after determining the channel puncturing patterns for the first subchannel and the second subchannel, the beamformee station wirelessly transmits a compressed beamforming CQI frame that includes information regarding the bandwidth of the channel, excluding any punctured parts (indicated by the channel puncturing patterns for the first and second subchannels).

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method by a wireless device functioning as a beamformer station in a wireless network to indicate a channel puncturing pattern for a sounding null data packet (NDP) frame, the method comprising:
generating the sounding NDP frame, wherein the sounding NDP frame indicates a channel puncturing pattern for a first subchannel of a channel and a channel puncturing pattern for a second subchannel of the channel; and
wirelessly transmitting the sounding NDP frame in the channel to one or more beamformee stations.

2. The method of claim 1, wherein the channel has a bandwidth of 320 MHz, the first subchannel has a bandwidth of 160 MHz, and the second subchannel has a bandwidth of 160 MHz.

3. The method of claim 2, wherein the sounding NDP frame includes a first field and a second field, wherein the first field is used to indicate the channel puncturing pattern for the first subchannel and the second field is used to indicate the channel puncturing pattern for the second subchannel.

4. The method of claim 3, wherein the first field is wirelessly transmitted in the first subchannel and the second field is wirelessly transmitted in the second subchannel.

5. The method of claim 4, wherein the first field is a U-SIG field that is wirelessly transmitted in the first subchannel and the second field is another U-SIG field that is wirelessly transmitted in the second subchannel.

6. The method of claim 3, wherein the first field is a U-SIG-2 field and the second field is a U-SIG-1 field.

7. The method of claim 6, wherein bits B3-B7 of the U-SIG-2 field are used to indicate the channel puncturing pattern for the first subchannel and bits B20-B24 of the U-SIG-1 field are used to indicate the channel puncturing pattern for the second subchannel.

8. The method of claim 3, wherein the first field is a U-SIG field and the second field is an EHT-SIG field with two symbols.

9. The method of claim 2, wherein the channel includes a plurality of odd numbered subchannels and a plurality of even numbered subchannels, wherein U-SIG fields that are wirelessly transmitted in the plurality of odd numbered subchannels are used to indicate the channel puncturing pattern for the first subchannel and U-SIG fields that are wirelessly transmitted in the plurality of even numbered subchannels are used to indicate the channel puncturing pattern for the second subchannel.

10. The method of claim 2, wherein the sounding NDP frame includes a first field and a second field, wherein four bits in the first field are used to indicate the channel puncturing pattern for the first subchannel, wherein one bit in the first field and three bits in the second field are used to indicate the channel puncturing pattern for the second subchannel.

11. A method by a wireless device functioning as a beamformee station in a wireless network to determine a channel puncturing pattern indicated by a sounding null data packet (NDP) frame, the method comprising:
wirelessly receiving the sounding NDP frame in a channel, wherein the sounding NDP frame indicates a bandwidth of the channel, a channel puncturing pattern for a first subchannel of the channel, and a channel puncturing pattern for a second subchannel of the channel; and
responsive to determining that the bandwidth of the channel indicated by the sounding NDP frame is a particular bandwidth, determining the channel puncturing pattern for the first subchannel and the channel puncturing pattern for the second subchannel from the sounding NDP frame.

12. The method of claim 11, wherein the particular bandwidth is 320 MHz, wherein the first subchannel has a bandwidth of 160 MHz, and the second subchannel has a bandwidth of 160 MHz.

13. The method of claim 12, wherein the channel puncturing pattern for the first subchannel is determined from a first field of the sounding NDP frame and the channel puncturing pattern for the second subchannel is determined from a second field of the sounding NDP frame.

14. The method of claim 13, wherein the first field is wirelessly received in the first subchannel and the second field is wirelessly received in the second subchannel.

15. The method of claim 14, wherein the first field is a U-SIG field that is wirelessly received in the first subchannel and the second field is another U-SIG field that is wirelessly received in the second subchannel.

16. The method of claim 13, wherein the first field is a U-SIG-2 field and the second field is a U-SIG-1 field.

17. The method of claim 16, wherein the channel puncturing pattern for the first subchannel is determined from bits B3-B7 of the U-SIG-2 field and the channel puncturing pattern for the second subchannel is determined from bits B20-B24 of the U-SIG-1 field.

18. The method of claim 13, wherein the first field is a U-SIG field and the second field is an EHT-SIG field with two symbols.

19. The method of claim 11, wherein the channel includes a plurality of odd numbered subchannels and a plurality of even numbered subchannels, wherein the channel puncturing pattern for the first subchannel is determined from a U-SIG field wirelessly received in one or more of the plurality of odd numbered subchannels and the channel puncturing pattern for the second subchannel is determined from a U-SIG field wirelessly received in one or more of the plurality of even numbered subchannels.

20. The method of claim 12, wherein the channel puncturing pattern for the first subchannel is determined from four bits in a first field of the sounding NDP frame and the channel puncturing pattern for the second subchannel is determined from one bit in the first field and three bits in a second field of the sounding NDP frame.
